(19) United States
(12) Patent Application Publication
(10) Pub. No.: US 2013/0163291 A1
(43) Pub. Date: Jun. 27, 2013

(54) SWITCH CIRCUIT, POWER SUPPLY DEVICE INCLUDING THE SAME, AND DRIVING METHOD THEREOF

(71) Applicants: Hyunmin KIM, Bucheon-si (KR); SangCheol MOON, Bucheon -si (KR); Young-Bae PARK, Anyang-city (KR)

(72) Inventors: Hyunmin KIM, Bucheon-si (KR); SangCheol MOON, Bucheon -si (KR); Young-Bae PARK, Anyang-city (KR)

(21) Appl. No.: 13/718,769

(22) Filed: Dec. 18, 2012

(30) Foreign Application Priority Data
Dec. 23, 2011 (KR) 10-2011-0141231

(51) Int. Cl. H01H 47/00; H02M 3/335

(52) U.S. Cl. CPC H01H 47/00; H02M 3/33507
USPC 363/21.12; 307/126

(57) ABSTRACT

The present invention relates to a switch circuit, a power supply including the same, and a method for driving the power supply. When a load of the power supply represents an overload state, a sense resistor for controlling a drain current flowing through a power switch is controlled. In this instance, the sense resistor is controlled according to an on-time of the power switch.

### CROSS-REFERENCE TO RELATED APPLICATION

This application claims priority to and the benefit of Korean Patent Application No. 10-2011-0141231 filed in the Korean Intellectual Property Office on Dec. 23, 2011, the entire contents of which are incorporated herein by reference.

### BACKGROUND OF THE INVENTION

(a) Field of the Invention

The present invention relates to a switch circuit, a power supply including the same, and a driving method thereof.

(b) Description of the Related Art

A power supply requires maintaining maximum output power when an input voltage is changed. The input voltage is generated by rectifying an AC input of the power supply and smoothing it through a smoothing capacitor. When the AC input is rectified, it becomes a full-wave rectified sine wave or a half-wave rectified sine wave, and when the rectified sine waves are smoothed, the input voltage has a voltage level within a predetermined range.

When the input voltage is changed, a rising slope of a current (hereinafter, drain current) flowing to a power switch during an on-time period of the power switch for controlling the power supply is changed depending on an input voltage. A predetermined delay period is generated so as to turn off the power switch, and the drain current rises during the delay period and a rising of the drain current is increased as a current rising slope becomes greater.

The drain current can exceed a peak current limit that corresponds to the maximum output power according to the increase of the rising of the drain current. When the drain current becomes greater than the peak current limit, output power that is greater than the maximum output power can be generated.

That is, the peak value of the drain current exceeds the peak current limit by the input voltage and the output power is controlled according to the drain current so the output power can exceed the maximum output power. Then, the maximum output power that is set for the power supply is not maintained but can be changeable depending on the input voltage.

Particularly, when a load connected to the power supply is an overload, a duty of the power switch is controlled to the maximum so output power exceeding the maximum output power can be frequently generated by the above-noted delay.

When the output power of the power supply exceeds the maximum output power, elements of the power supply can be exposed to heavy stresses.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to control a drain current of a power switch to not exceed a peak current limit.

An exemplary embodiment of the present invention provides a switch circuit for controlling a power supply including a power transmitting element for transmitting an input voltage that is input to a first end to a second end.

The switch circuit includes a power switch, and a sense resistor for sensing a drain current flowing through the power switch, wherein when a load of the power supply represents an overload state, the sense resistor is controlled according to an on-time of the power switch.

The switch circuit detects the on-time when the load represents an overload state, and it controls the sense resistor according to the detected on-time so that a drain current of the power switch may not exceed a peak current limit corresponding to a maximum output power.

The switch circuit includes an on-time detector for detecting an on-time by using a signal for controlling the power switch during the overload period, and an overload comparator for determining an overload state by using a feedback voltage corresponding to an output voltage of the power supply.

The overload comparator includes a first end for receiving a reference voltage for determining the overload state, and a second end for receiving the feedback voltage, and the overload comparator determines a period in which the feedback voltage is greater than the reference voltage to be an overload period.

The on-time detector detects the on-time by using a gate signal for switching the power switch during the overload period.

The on-time detector includes: a logical operator for generating an on-time voltage according to an output of the overload comparator and the gate signal; a counter enabled by the on-time voltage and generating a count output signal following the on-time counting result by using predetermined count clock signals; a decoder for generating a plurality of resistor control signals for controlling the sense resistor according to the count output signal; and a register for reading and storing the resistor control signals in synchronization with a time when the gate signal turns off the power switch.

The counter includes N T-flip-flops that are enabled by the on-time voltage and are sequentially connected, wherein the N T-flip-flops while in the enabled state invert an output signal and an inverted output signal for each period of a signal that is input to an input end, and output the inverted signals through an output end and an inverted output end, and the count output signal represents an n-bit signal that is generated by sequentially arranging output signals of the N T-flip-flops in a connected order of the N T-flip-flops.

The N T-flip-flops further include an enable end for receiving the on-time voltage, an inverted output signal of a previous T-flip-flop is input to an input end of a next T-flip-flop, and the N T-flip-flops include a first T-flip-flop for transmitting the count clock signal to the input end.

The N T-flip-flops reset output signals of the N T-flip-flops when the overload period is finished or when the power switch is turned off.

The decoder generates 2̂n resistor control signals to the maximum depending on the n-bit signal.

The sense resistor includes a plurality of resistor switches having first ends connected to the power switch, and a plurality of control resistors connected to second ends of the resistor switches, wherein the resistor switches respectively perform a switching operation according to the corresponding resistor control signals.

The switch circuit further includes a switch control circuit for controlling the power switch according to a sense voltage provided by the sense resistor, a feedback signal corresponding to an output voltage of the power supply, and a clock signal for determining a switching frequency of the power switch.

The switch control circuit includes a PWM controller for turning on the power switch in synchronization with the clock signal, and turning off the power switch according to a result generated by comparing a feedback voltage corresponding to the feedback signal and the sense voltage.

Another embodiment of the present invention provides a power supply for supplying power to a load by using an input voltage, including: a power transmitting element connected between the input voltage and the load; and a switch circuit including a power switch having a first end connected to the power transmitting element, and a sense resistor for sensing a drain current flowing through the power switch, the switch circuit controlling the power switch, wherein the switch circuit controls the sense resistor by using an on-time of the power switch when the load represents an overload state.

The switch circuit controls the sense resistor by using an on-time of the power switch when the load represents an overload state.

The on-time detector includes: a logical operator for generating an on-time voltage according to an output of the overload comparator and the gate signal; a counter enabled by the on-time voltage and generating a count output signal following the on-time counting result by using predetermined count clock signals; a decoder for generating a plurality of resistor control signals for controlling the sense resistor according to the count output signal; and a register for reading and storing the resistor control signals in synchronization with a time when the gate signal turns off the power switch.

Yet another embodiment of the present invention provides a method for driving a power supply including a power switch and a sense resistor connected to the power switch, including: sensing a drain current flowing at an on-time of the power switch by using the sense resistor; controlling the power switch by using the sensed drain current and a feedback voltage corresponding to an output voltage of the power supply; detecting an on-time of the power switch when a load of the power supply represents an overload state; and controlling the sense resistor according to the detected on-time.

The controlling of a sense resistor includes controlling the sense resistor according to the detected on-time so that the drain current may not exceed a peak current limit that corresponds to a maximum output power.

The switch circuit, the power supply including the same, and the driving method thereof according to the exemplary embodiments of the present invention prevent generation of an output power exceeding the maximum output power by controlling the drain current of the power switch to not exceed the peak current limit.

### BRIEF DESCRIPTION OF THE DRAWINGS

FIG. 1 shows a power supply according to an exemplary embodiment of the present invention.

FIG. 2 shows an on-time detector according to an exemplary embodiment of the present invention.

FIG. 3 shows a waveform diagram of a count clock signal, an on-time voltage, a plurality of output signals, and a plurality of inverted output signals according to an exemplary embodiment of the present invention.

FIG. 4 shows a configuration of a sense resistor according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

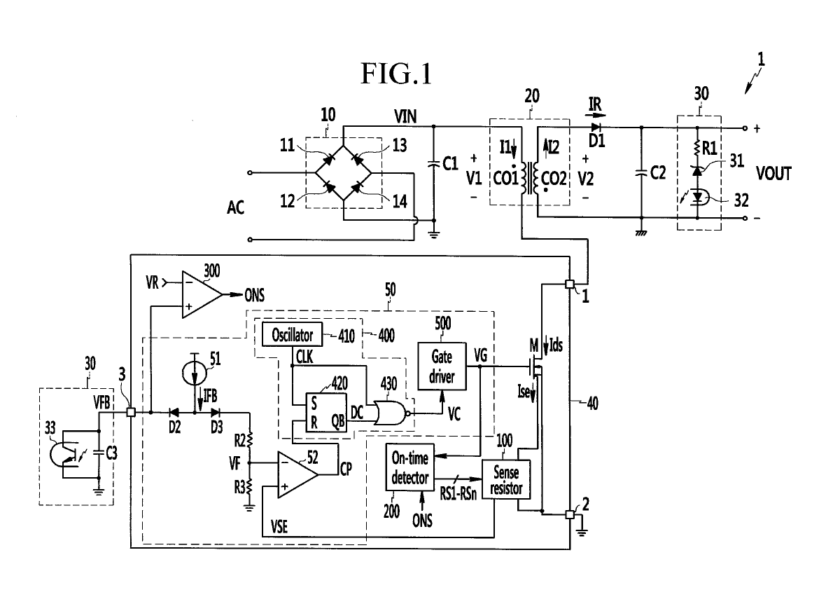

FIG. 1 shows a power supply according to an exemplary embodiment of the present invention.

As shown in FIG. 1, the power supply 1 includes a bridge rectifying diode 10, a smoothing capacitor C1, a transformer 20, a feedback circuit 30, a switch circuit 40, a rectifying diode D1, and an output capacitor C2.

The power supply is realized by using a flyback convertor, and the present invention is not limited thereto. A transformer is applied as a power transmitting element, and other types of converters using an inductor are applicable to the exemplary embodiment of the present invention.

The bridge rectifying diode 10 rectifies an AC input (AC) to generate an input voltage (VIN). The bridge rectifying diode 10 includes four diodes 11-14.

The smoothing capacitor C1 smoothes a ripple component of the input voltage (VIN).

The transformer 20 transforms power of the primary coil generated by the input voltage (VIN) and transmits the transformed result to a secondary coil. The transformer 20 includes a first coil CO1 provided as the primary coil and a second coil CO2 provided as the secondary coil. The first coil CO1 includes a first end for receiving the input voltage (VIN) and a second end connected to a power switch (M). The second coil CO2 is formed on the secondary coil, and the second coil CO2 generates a voltage and a current by power transmitted by the primary coil.

A turn ratio (a turn number of CO2 ns/a turn number of CO1 np) nps is determined according to the turn number of the first coil CO1 and the turn number of the second coil CO2. The ratio V2/V1 between the voltage V1 of the first coil CO1 and the voltage V2 of the second coil CO2 of the transformer 20 is proportional to the turn ratio nps, and the ratio I2/I1 between the current I1 of the first coil CO1 and the current I2 of the second coil CO2 is inversely proportional to the turn ratio nps.

The diode D1 includes an anode connected to a first end of the second coil CO2 and a cathode connected to a first end of the output capacitor C2. The diode D1 rectifies a current I2 flowing to the second coil CO2. The current (IR) flowing through the diode D1 is supplied to a load or charges the output capacitor C2.

The output capacitor C2 is charged by the current (IR) or it is discharged to supply the current to the load.

The power switch (M) is connected to the first coil CO1, and the current I1 flowing to the first coil CO1 is controlled by the power switch (M). The power switch (M) has been shown to be included in the switch circuit 40 in the exemplary embodiment of the present invention, but the present invention is not limited thereto. For example, the power switch (M) can be formed outside the switch circuit 40.

The current I1 is increased while the power switch (M) is turned on, and it does not flow while the power switch (M) is turned off. While the power switch (M) is turned on, the current I1 is increased and energy is stored in the first coil CO1. In this instance, the rectifying diode D1 is turned off so no current flows through the second coil CO2. While the power switch (M) is turned off, the current I2 at the secondary coil CO2 flows to the anode of the rectifying diode D1 from the second coil CO2 and is then rectified through the rectifying diode D1 to generate the current (IR).

When the load connected to an output end of the power supply 1 is increased to increase the current that is supplied to the load, the output capacitor C2 is discharged to reduce the output voltage (VOUT). On the contrary, when the load is reduced to reduce the current that is supplied to the load, the output capacitor C2 is charged by the current (IR) to increase the output voltage (VOUT).

The feedback circuit 30 generates a feedback signal (VFB) corresponding to the output voltage (VOUT) and transmits it to the switch circuit 40. The feedback signal (VFB) is changeable by the output voltage (VOUT).

The feedback circuit 30 includes a resistor R1, a shunt regulator 31, a photodiode 32, a capacitor C3, and a phototransistor 33. The resistor R1, the shunt regulator 31, and the photodiode 32 are coupled in series between an output end (+) and a predetermined power such as a ground end. The phototransistor (PT) is connected between a feedback end 5 of the switch circuit 40 and a predetermined power such as the ground end, and it forms an opto-coupler together with the photodiode 32.

The shunt regulator 31 is conductive by the output voltage (VOUT), and a current corresponding to the output voltage (VOUT) flows through the photodiode 32. A current flows between a collector and an emitter of the phototransistor 33 according to the current that flows through the photodiode 32.

When the current flowing through the phototransistor 33 is increased, impedance connected to the feedback end 5 is increased and the feedback signal (VFB) is reduced. On the contrary, when the current flowing through the phototransistor 33 is reduced, impedance connected to the feedback end 5 is increased and the feedback signal (VFB) is increased.

Therefore, when the output voltage (VOUT) is increased, the feedback signal (VFB) is reduced, and when the output voltage (VOUT) is reduced, the feedback signal (VFB) is increased.

The switch circuit 40 includes a power switch (M), a switch control circuit 50, a sense resistor 100, an on-time detector 200, and an overload comparator 300. The power switch (M) represents an n-channel type transistor.

The switch circuit 40 controls the power switch (M) to control the power supply operation for transforming the primary coil power and transmitting the transformed result to the secondary coil. In this instance, the switch circuit 40 receives the output voltage (VOUT) and controls the power switch (M) so that the output voltage (VOUT) may be constant.

While in the overload state, the switch circuit 40 detects an on-time of the power switch (M) to estimate the input voltage (VIN) and controls the sense resistor 100 according to the input voltage (VIN) to maintain the maximum drain current.

In order to maintain the maximum output power, the drain current (Ids) must be maintained at the maximum drain current. The maximum drain current according to prior art is changeable according to a turn-off delay of the power switch (M).

For example, the maximum drain current is variable by a rising slope deviation of the drain current caused by the input voltage during a delay period occurring by a turn-off operation of the power switch according to the conventional art. When the maximum drain current corresponding to the maximum output power is set to be a peak current limit, the drain current according to conventional art can be greater than the peak current limit depending on the input voltage. Therefore, output power exceeding the maximum output power is generated.

The switch circuit 40 in the overload state controls the sense resistor 100 according to a length of the on-time period of the power switch (M) to control the switching operation so that the drain current (Ids) may not be greater than the peak current limit. In the overload state, as the on-time of the power switch (M) is increased, the input voltage (VIN) becomes less, and as the on-time of the power switch (M) is reduced, the input voltage (VIN) becomes greater.

Hence, the switch circuit 40 reduces the sense resistor 100 as the on-time is longer and it increases the sense resistor 100 as the on-time is shorter. That is, the switch circuit 40 controls a level of the sense voltage (VSE) according to the input voltage (VIN) and controls the turn-off time according to the controlled sense voltage (VSE) to prevent the drain current (Ids) from exceeding the peak current limit.

In detail, the switch circuit 40 includes an on-time detector 200 for controlling the sense resistor 100 according to the input voltage (VIN). The switch circuit 40 determines a turn-off time of the power switch (M) according to the sense voltage (VSE) transmitted by the sense resistor 100.

For example, when the input voltage (VIN) is great, the sense resistor 100 is increased and the level of the sense voltage (VSE) is increased. Then, the turn-off time of the power switch (M) is advanced by the sense voltage (VSE) that is relatively greater than the case in which the input voltage (VIN) is less. The drain current (Ids) does not exceed the peak current limit and the maximum output power is maintained.

The on-time detector 200 counts on-times of a gate signal (VG) so as to sense the input voltage (VIN). As described above, the on-time of the gate signal (VG) is increased as the input voltage (VIN) becomes less under the same load condition, and the on-time of the gate signal (VG) is reduced as the input voltage (VIN) becomes greater.

Therefore, the on-time detector 200 reduces the sense resistor 100 as the sensed on-time becomes longer, and it increases the variable resistor 100 as the sensed on-time is shorter. The switch circuit 40 directly senses the input voltage (VIN) to provide the same efficiency of the case for reducing the peak current limit as the input voltage (VIN) becomes greater and increasing the peak current limit as the input voltage (VIN) becomes lesser.

An operation for the on-time detector 200 to control the sense resistor 100 according to the input voltage (VIN) will be referred to as a power limit compensation.

The drain current (Ids) reaches the peak current limit under the overload condition. That is, when the load connected to the power supply 1 is an overload, the on-time of the power switch (M) is increased so the drain current (Ids) can rise to the peak current limit.

The switch circuit 40 performs the power limit compensation under the overload condition. The switch circuit 40 includes an overload comparator 300 for comparing a feedback signal (VFB) and a predetermined reference voltage (VR) so as to determine the overload condition.

The overload comparator 300 includes a non-inverting end (+) for receiving the feedback signal (VFB) and an inverting terminal (−) for receiving a reference voltage (VR), and generates a high-level on-time detecting signal (ONS) when the feedback signal (VFB) becomes greater than the reference voltage (VR). The overload comparator 300 generates a low-level on-time detecting signal (ONS) when the feedback signal (VFB) is less than the reference voltage (VR). The on-time detector 200 detects the on-time during a time when the high-level on-time detecting signal (ONS) is generated.

The switch control circuit 50 controls the power switch (M) according to the sense voltage (VSE) transmitted by the sense resistor 100, the feedback signal (VFB), and clock signals CLK for determining a switching frequency.

The switch control circuit 50 includes a feedback current source 51, a comparator 52, a PWM controller 400, and a gate driver 500.

The feedback current source 51 supplies the current for an operation of the feedback circuit 30, and supplies the current for generating the feedback voltage (VF) corresponding to the feedback signal (VFB).

The diode D2 includes an anode connected to the feedback current source 51 and a cathode connected to the feedback circuit 30. The diode D3 includes an anode connected to the feedback current source 51 and a cathode connected to a first end of a resistor R2.

A second end of the resistor R2 is connected to a first end of the resistor R3, and a voltage at a node of the resistor R2 and the resistor R3 represents a feedback voltage (VF). A feedback current (IFB) of the feedback current source 51 includes a current flowing through the diode D2 and a current flowing to the resistor R2 and the resistor R3 through the diode D3.

The current flowing through the diode D2 follows the current flowing through the phototransistor 33, and the current that is generated by subtracting the current flowing through the diode D2 from the feedback current (IFB) flows through the diode D3. The feedback voltage (VF) is determined by the current flowing through the diode D3 and the resistor R3.

The comparator 52 includes a non-inverting end (+) for receiving the sense voltage (VSE) and an inverting end (−) for receiving the feedback voltage (VF), and it generates a high-level comparing signal (CP) when the sense voltage (VSE) is greater than the feedback voltage (VF) and it generates a low-level comparing signal (CP) when the sense voltage (VSE) is less than the feedback voltage (VF).

The PWM controller 400 turns on the power switch (M) in synchronization with the clock signals CLK, and it turns off the power switch (M) in synchronization with the comparing signal (CP). The PWM controller 400 includes an oscillator 410, an SR flip-flop 420, and a logical operator 430.

The oscillator 410 generates the clock signals CLK.

The SR flip-flop 420 generates a duty control signal (DC) for controlling a power switch duty according to the clock signal CLK and the comparing signal (CP).

The SR flip-flop 420 includes a set end (S) for receiving the clock signals CLK, a reset end (R) for receiving the comparing signal (CP), and an inverted output end (QB) for outputting a duty control signal (DC). The SR flip-flop 420 generates a low-level output in synchronization with a rising edge of an input of the set end (S), and it generates a high-level output in synchronization with a rising edge of an input of the reset end (R). The output of the SR flip-flop 420 is output through the inverted output end (QB).

The logical operator 430 receives the clock signal CLK and the duty control signal (DC), and generates a gate control signal (VC). When the level of the gate control signal (VC) according to the clock signal CLK and the duty control signal (DC) is determined, a logical operation method of the logical operator 430 is determined. The logical operator 430 is realized by a NOR gate for performing a NOR operation.

The gate driver 500 generates a gate signal (VG) according to the gate control signal (VC). The gate driver 500 generates a high-level gate signal (VG) according to the high-level gate control signal (VC), and generates a low-level gate signal (VG) according to the low-level gate control signal (VC).

The SR flip-flop 420 outputs a low-level duty control signal (DC) by the rising edge of the clock signal CLK. The logical operator 430 outputs a high-level gate control signal (VC) since input signals of the logical operator 430 become low level when the high-level pulse of the clock signal CLK is finished. The power switch (M) is turned on by the high-level gate signal (VG).

When the sense voltage (VSE) reaches the feedback voltage (VF) after the power switch (M) is turned on, the output of the comparator 52 becomes high level. The SR flip-flop 420 generates a high-level duty control signal (DC) according to the high-level comparing signal (CP), and the logical operator 430 generates a low-level gate control signal (VC). The power switch (M) is turned off when the sense voltage (VSE) reaches the feedback voltage (VF).

The on-time detector 200 is enabled by the on-time detecting signal (ONS), and it uses the gate signal (VG) to detect the on-time. The on-time detector 200 can use the gate control signal (VC) other than the gate signal (VG).

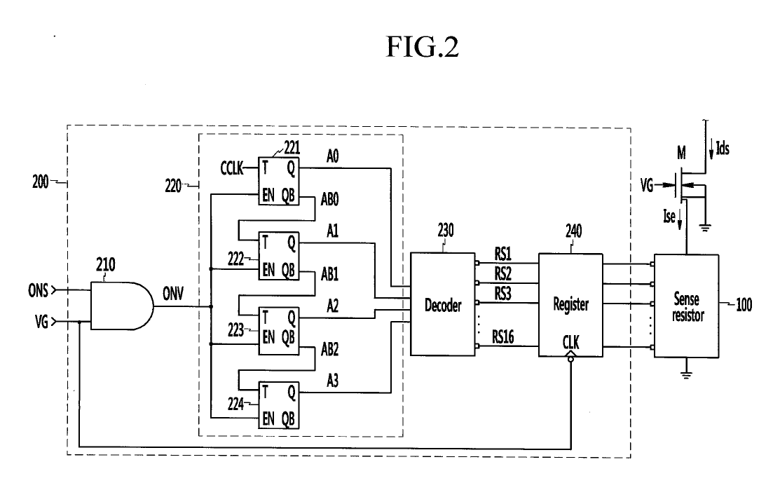

An on-time detector 200 according to an exemplary embodiment of the present invention will now be described with reference to FIG. 2.

FIG. 2 shows an on-time detector according to an exemplary embodiment of the present invention.

As shown in FIG. 2, the on-time detector 200 includes a logical operator 210, a counter 220, a decoder 230, and a register 240.

The logical operator 210 enables or disables the counter 220 according to the on-time detecting signal (ONS) and the gate signal (VG). The logical operator 210 is realized with an AND gate. An enable level of the on-time detecting signal (ONS) and a level for the gate signal (VG) to turn on the power switch (M) are high levels so the logical operator 210 in the overload state generates a high-level on-time voltage (ONV) during an ON period of the power switch (M), that is, the on-time period. The high-level on-time voltage (ONV) enables the counter 220.

The counter 220 generates an output signal according to the on-time counting result. The counter 200 is enabled by the on-time voltage (ONV) and then counts the on-time. The counter 220 counts the on-time by using the count clock signal (CCLK).

The counter 220 includes four T-flip-flops (221-224). The present invention is not limited thereto.

The counter 220 outputs the count result as an n-bit signal. The output of the counter 220 represents an n-bit signal configured with output signals of a plurality of T-flip-flops.

A number of the T-flip-flops and a frequency of the count clock signal (CCLK) are controllable by the maximum period of the on-time. For example, the number of the T-flip-flops can be increased as the maximum period of the on-time becomes longer. Also, the frequency of the count clock signal can be increased so as to further accurately count the on-time period.

The T-flip-flops (221-224) respectively include an input end (T), an enable end (EN), an output end (Q), and an inverted output end (QB). The T-flip-flops (221-224) are enabled by a high-level signal that is input to the enable end (EN) and they are disabled by a low-level signal that is input to the enable end (EN), and output signals (A0-A3) are reset.

The T-flip-flops (221-224) are reset by at least one of the time when the overload state is finished and the time when the power switch (M) is turned off, and they reset the output signals (A0-A3). The output signals (A0-A3) are reset with the low level representing the logical value “0.”

Inverted output signals (AB0-AB3) are reset to be high level.

The T-flip-flops (221-224) can be reset by at least one of the on-time detecting signal (ONS) and the gate signal (VG). That is, they can be reset by the falling edge time when one of the high-level on-time detecting signal (ONS) and the high-level gate signal (VG) is switched to the low level.

The T-flip-flops (221-224) in the enabled state invert output signals and inverted output signals for each period of the signal that is input to the input end (T) and output inverted resultant signals to the output end (Q) and the inverted output end (QB). An on-time voltage (ONV) is input to the enable ends (EN) of the T-flip-flops (221-224).

Count clock signals (CCLK) are input to the input end (T) of the T-flip-flop 221, and the T-flip-flop 221 inverts the output signal A0 and the inverted output signal AB0 for each period of the count clock signal (CCLK) and outputs the inverted signals. In detail, the T-flip-flop 221, while in the enabled state, inverts the output signal A0 and the inverted output signal AB0 and outputs the inverted signals in synchronization with the rising edge of the signal that is input to the input end (T).

The inverted output signal AB0 is input to the input end (T) of the T-flip-flop 222, and the T-flip-flop 222 inverts the output signal A1 and the inverted output signal AB1 for each period of the inverted output signal AB0 and outputs the inverted signals. In detail, the T-flip-flop 222, while in the enabled state, inverts the output signal A1 and the inverted output signal AB1 and outputs the inverted signals in synchronization with the rising edge of the signal that is input to the input end (T).

The inverted output signal AB1 is input to the input end (T) of the T-flip-flop 223, and the T-flip-flop 223 inverts the output signal A2 and the inverted output signal AB2 and outputs the inverted signals for each period of the inverted output signal AB1. In detail, the T-flip-flop 223, while in the enabled state, inverts the output signal A2 and the inverted output signal AB2 and outputs the inverted signals in synchronization with the rising edge of the signal that is input to the input end (T).

The inverted output signal AB2 is input to the input end (T) of the T-flip-flop 224, and the T-flip-flop 224 inverts the output signal A3 and the inverted output signal AB3 and outputs the inverted signals for each period of the inverted output signal AB2. In detail, the T-flip-flop 224, while in the enabled state, inverts the output signal A3 and the inverted output signal AB3 and outputs the inverted signals in synchronization with the rising edge of the signal that is input to the input end (T).

The decoder 230 generates a plurality of resistor control signals (RS1-RSn) for controlling resistance of the sense resistor 100 according to the counting result that is output by the counter 220. The output of the counter 220 represents an n-bit signal, and the decoder 230 generates 2̂n-numbered resistor control signals (RS1-RSn) according to the n-bit signal.

In the exemplary embodiment of the present invention, a 4-bit signal is input to the decoder 230. The output of the counter 220 represents a 4-bit signal that is determined in the order of A3, A2, A1, and A0. Therefore, the decoder 230 can generate sixteen resistor control signals (RS1-RS16).

The register 240 reads and stores a plurality of resistor control signals (RS1-RSn) of the decoder 230 when the gate signal (VG) that is input to the clock signal end CLK falls, and resistance of the sense resistor 100 is controlled by the resistor control signals (RS1-RSn).

The sense resistor 100 is controlled by the resistor control signals (RS1-RSn). The sense resistor 100 is reduced as enable levels are increased from among the resistor control signals (RS1-RSn).

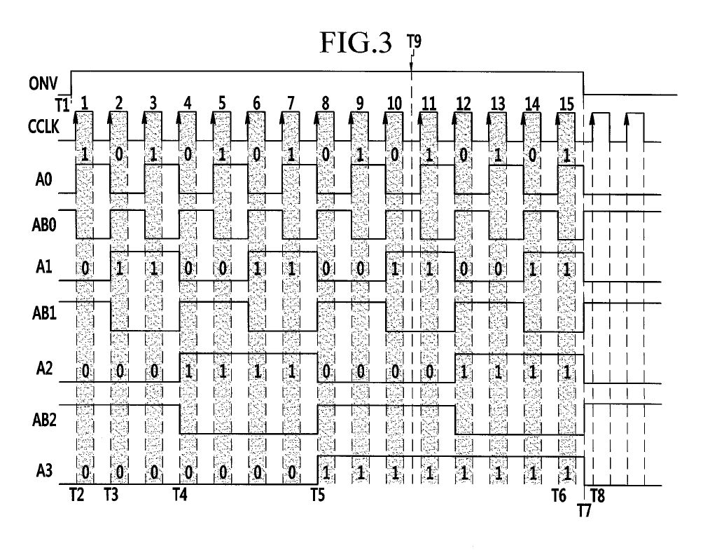

An operation of an on-time detector 200 according to an exemplary embodiment of the present invention will now be described with reference to FIG. 3.

FIG. 3 shows a waveform diagram of a count clock signal, an on-time voltage, a plurality of output signals, and a plurality of inverted output signals according to an exemplary embodiment of the present invention.

At the time T1, when the on-time voltage (ONV) becomes high level, the T-flip-flops (221-224) are enabled.

At the time T2, the T-flip-flop 221 inverts the output signal A0 and inverted output signal AB0 and outputs the inverted signals in synchronization with the rising edge of the count clock signals (CCLK). At the time T3, the T-flip-flop 221 inverts the output signal A0 and the inverted output signal AB0 and outputs the inverted signals in synchronization with the rising edge of the count clock signal (CCLK). As described, the output signal A0 and the inverted output signal AB0 of the T-flip-flop 221 are inverted and output for each period of the count clock signal (CCLK).

At the time T3, the T-flip-flop 222 inverts the output signal A1 and the inverted output signal AB1 and outputs the inverted signals in synchronization with the rising edge of the inverted output signal AB0. At the time T4, the T-flip-flop 222 inverts the output signal Al and the inverted output signal AB1 and outputs the inverted signals in synchronization with the rising edge of the inverted output signal AB0. As described, the output signal A1 and the inverted output signal AB1 of the T-flip-flop 222 are inverted and output for each period of the inverted output signal AB0.

At the time T4, the T-flip-flop 223 inverts the output signal A2 and the inverted output signal AB2 and outputs the inverted signals in synchronization with the rising edge of the inverted output signal AB1. At the time T5, the T-flip-flop 223 inverts the output signal A2 and the inverted output signal AB2 and outputs the inverted signals in synchronization with the rising edge of the inverted output signal AB1. As described, the output signal A2 and the inverted output signal AB2 of the T-flip-flop 223 are inverted and output for each period of the inverted output signal AB1.

At the time T5, the T-flip-flop 224 inverts the output signal A3 and the inverted output signal AB3 and outputs the inverted signals in synchronization with the rising edge of the inverted output signal AB2. At the time T6, the output signal A0 becomes high level in synchronization with the rising edge of the count clock signal (CCLK).

For example, the output signal of the counter 220 at the time T6 is a 4-bit signal “1111” that is determined with A3, A2, A1, and A0.

At the time T7, the gate signal (VG) becomes low level and the on-time voltage (ONV) becomes low level, the T-flip-flops (221-224) are disabled, and the output states of the T-flip-flops (221-224) are reset to be low level. A falling edge of the gate signal (VG) is generated at the time T7 so the decoder 230 reads and stores a plurality of resistor control signals (RS1-RSn) at the time T7. Therefore, the sense resistor 100 has the least resistance according to the resistor control signals (RS1-RSn).

An output signal “1111” (15 as a decimal number) of the counter 220 corresponding to the on-time voltage (ONV) shown in FIG. 3 represents the maximum count number of the counter 220. The on-time voltage (ONV) shown in FIG. 3 represents an example so when the on-time voltage (ONV) becomes low level by a low-level gate signal (VG) occurring at the time T9, a plurality of resistor control signals (RS1-RSn) following the count output signal “1010” (10 as a decimal number) of the counter 220 are stored in the register 240, and resistance of the sense resistor 100 is determined by the resistor control signals (RS1-RSn).

Values from 0 to 15 are expressed as 4-bit signals by the output signals A3, A2, A1, and A0. For ease of understanding, FIG. 3 shows the 4-bit count output signal sequentially arranged in the order of A3, A2, A1, and A0 and defined with shading.

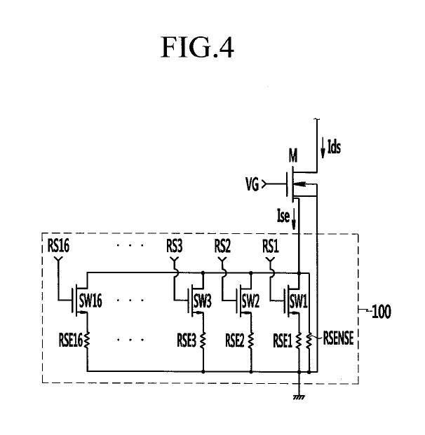

A sense resistor 100 shown with reference to FIG. 4 will now be described.

FIG. 4 shows a configuration of a sense resistor according to an exemplary embodiment of the present invention. As shown in FIG. 4, the sense resistor 100 includes a default resistor (RSENSE), a plurality of control resistors (RSE1-RSE16), and a plurality of resistor switches (SW1-SW16).

The default resistor (RSENSE) is connected between a source electrode of a power switch (M) and a ground. A maximum number of control resistors included by the sense resistor 100 is determined by a bit number n of the counter output signal. FIG. 4 shows that sixteen control resistors (RSE1-RSE16) are included in the sense resistor 100 according to a 4-bit counter output signal. However, the present invention is not limited thereto.

The resistor switches (SW1-SW16) perform a switching operation by a plurality of resistor control signals (RS1-RSn). The resistor switches (SW1-SW16) are realized by n-channel type transistors, and the present invention is not limited thereto.

The enable level of the resistor control signals (RS1-RSn) represents a level for turning on the corresponding resistor switches (SW1-SW16), and the disable level of the resistor control signals (RS1-RSn) indicates a level for turning off the corresponding resistor switches (SW1-SW16). Therefore, the enable level is a high level and the disable level is a low level.

The resistor control signals (SW1-SW16) are input to the corresponding gate electrodes of the resistor switches (SW1-SW16), drain electrodes of the resistor switches (SW1-SW16) are connected to a source electrode of the power switch (M), and source electrodes of the resistor switches (SW1-SW16) are connected to first ends of the corresponding control resistors (RSE1-RSE16). Second ends of the control resistors (RSE1-RSE16) are grounded.

The control resistor connected to the turned-on resistor switch from among the resistor switches (SW1-SW16) is connected in parallel with the default resistor (RSENSE). Hence, as the number of turned-on resistor switches is increased, the sense resistor 100 is controlled depending on the number of the control resistors connected in parallel to the default resistor (RSENSE).

That is, the on-time is increased as the input voltage becomes lower, and the sense resistor 100 is reduced when the number of the turned-on resistor switches is increased. Therefore, the sense voltage (VSENSE) that is generated when the sense current (Ise) flows through the sense resistor 100 is reduced compared to the case in which the input voltage is great. Therefore, the peak of the drain current (Ids) is controlled at a greater value than the case in which the input voltage is great.

On the contrary, the on-time becomes short as the input voltage is increased, and the sense resistor 100 becomes great when the number of the turned-on resistor switches is reduced. Therefore, the sense voltage (VSENSE) that is generated when the sense current (Ise) flows through the sense resistor 100 becomes great compared to the case in which the input voltage is low. Hence, the peak of the drain current (Ids) is controlled at a lower value than the case when the input voltage is low.

Accordingly, the switch circuit and the power supply according to the exemplary embodiment of the present invention can maintain the maximum output power in the case of an overload state by using power limit compensation. The input voltage is sensed by using the on-time without a configuration for sensing the input voltage, and the peak of the drain current is controlled according to the input voltage that is sensed in the overload state.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A switch circuit for controlling a power supply including a power transmitting element for transmitting an input voltage that is input to a first end to a second end, comprising:
a power switch; and
a sense resistor for sensing a drain current flowing through the power switch, wherein
when a load of the power supply represents an overload state, the sense resistor is controlled according to an on-time of the power switch.

2. The switch circuit of claim 1, wherein
the switch circuit detects the on-time when the load represents an overload state, and it controls the sense resistor according to the detected on-time so that a drain current of the power switch may not exceed a peak current limit corresponding to a maximum output power.

3. The switch circuit of claim 2, wherein
the switch circuit includes:
an on-time detector for detecting an on-time by using a signal for controlling the power switch during the overload period; and
an overload comparator for determining an overload state by using a feedback voltage corresponding to an output voltage of the power supply.

4. The switch circuit of claim 3, wherein
the overload comparator includes:
a first end for receiving a reference voltage for determining the overload state; and
a second end for receiving the feedback voltage, and
the overload comparator determines a period in which the feedback voltage is greater than the reference voltage to be an overload period.

5. The switch circuit of claim 3, wherein
the on-time detector detects the on-time by using a gate signal for switching the power switch during the overload period.

6. The switch circuit of claim 5, wherein
the on-time detector includes:
a logical operator for generating an on-time voltage according to an output of the overload comparator and the gate signal;
a counter enabled by the on-time voltage and generating a count output signal following the on-time counting result by using predetermined count clock signals;
a decoder for generating a plurality of resistor control signals for controlling the sense resistor according to the count output signal; and
a register for reading and storing the resistor control signals in synchronization with a time when the gate signal turns off the power switch.

7. The switch circuit of claim 6, wherein
the counter includes N T-flip-flops that are enabled by the on-time voltage and are sequentially connected,
wherein the N T-flip-flops while in the enabled state invert an output signal and an inverted output signal for each period of a signal that is input to an input end, and output the inverted signals through an output end and an inverted output end, and
the count output signal represents an n-bit signal that is generated by sequentially arranging output signals of the N T-flip-flops in a connected order of the N T-flip-flops.

8. The switch circuit of claim 7, wherein
the N T-flip-flops further include an enable end for receiving the on-time voltage,
an inverted output signal of a previous T-flip-flop is input to an input end of a next T-flip-flop, and
the N T-flip-flops include a first T-flip-flop for transmitting the count clock signal to the input end.

9. The switch circuit of claim 8, wherein
the N T-flip-flops reset output signals of the N T-flip-flops when the overload period is finished or when the power switch is turned off.

10. The switch circuit of claim 7, wherein
the decoder generates 2An resistor control signals to the maximum depending on the n-bit signal.

11. The switch circuit of claim 10, wherein
the sense resistor includes
a plurality of resistor switches having first ends connected to the power switch; and
a plurality of control resistors connected to second ends of the resistor switches,
wherein the resistor switches respectively perform a switching operation according to the corresponding resistor control signals.

12. The switch circuit of claim 1, further including
a switch control circuit for controlling the power switch according to a sense voltage provided by the sense resistor, a feedback signal corresponding to an output voltage of the power supply, and a clock signal for determining a switching frequency of the power switch.

13. The switch circuit of claim 12, wherein
the switch control circuit includes a PWM controller for turning on the power switch in synchronization with the clock signal, and turning off the power switch according to a result generated by comparing a feedback voltage corresponding to the feedback signal and the sense voltage.

14. A power supply for supplying power to a load by using an input voltage, comprising:
a power transmitting element connected between the input voltage and the load; and
a switch circuit including a power switch having a first end connected to the power transmitting element, and a sense resistor for sensing a drain current flowing through the power switch, the switch circuit controlling the power switch, wherein
the switch circuit controls the sense resistor by using an on-time of the power switch when the load represents an overload state.

15. The power supply of claim 14, wherein
the switch circuit detects the on-time when the load represents the overload state, and it controls the sense resistor according to the detected on-time so that a drain current of the power switch may not exceed a peak current limit that corresponds to a maximum output power

16. The power supply of claim 15, wherein
the switch circuit includes:
an on-time detector for detecting an on-time by using a signal for controlling the power switch during the overload period; and
an overload comparator for determining an overload state by using a feedback voltage corresponding to an output voltage of the power supply.

17. The power supply of claim 16, wherein
the on-time detector detects the on-time by using a gate signal for switching the power switch during the overload period.

18. The power supply of claim 17, wherein
the on-time detector includes:
a logical operator for generating an on-time voltage according to an output of the overload comparator and the gate signal;
a counter enabled by the on-time voltage and generating a count output signal following the on-time counting result by using predetermined count clock signals;
a decoder for generating a plurality of resistor control signals for controlling the sense resistor according to the count output signal; and
a register for reading and storing the resistor control signals in synchronization with a time when the gate signal turns off the power switch.

19. A method for driving a power supply including a power switch and a sense resistor connected to the power switch, comprising:
sensing a drain current flowing at an on-time of the power switch by using the sense resistor;
controlling the power switch by using the sensed drain current and a feedback voltage corresponding to an output voltage of the power supply;
detecting an on-time of the power switch when a load of the power supply represents an overload state; and
controlling the sense resistor according to the detected on-time.

20. The method of claim 19, wherein
the controlling of a sense resistor includes
controlling the sense resistor according to the detected on-time so that the drain current may not exceed a peak current limit that corresponds to a maximum output power.
